(19) United States
(12) Patent Application Publication
(10) Pub. No.: US 2022/0347726 A1
(43) Pub. Date: Nov. 3, 2022

(54) FLEXIBLE SUCTION TOOL FOR A GRABBING APPARATUS

(71) Applicant: Industries Machinex, Plessisville (CA)

(72) Inventor: Marc MASSÉ, Princeville (CA)

(21) Appl. No.: 17/863,597

(22) Filed: Jul. 13, 2022

Related U.S. Application Data
(63) Continuation-in-part of application No. 17/605,277, filed on Oct. 21, 2021.
(60) Provisional application No. 62/879,880, filed on Jul. 29, 2019.

(51) Int. Cl. B07C 5/36; B07C 5/342

(52) U.S. Cl. CPC B07C 5/365; B07C 5/342; B07C 2501/0063

(57) ABSTRACT

A suction tool for a system for sorting materials with a vacuum tube, the suction tool comprising a body of flexible material wall to be installed at a distal end of the vacuum tube and forming a tubular wall. It is shaped with alternating rims and waists, and from a proximal end of the suction tool to a distal end thereof; an average diameter decreasing distally over a length of the body of flexible material. Each rim has said local rim diameter larger the local rim diameter of a next one of the rims; each waist has said local waist diameter larger the local waist diameter of a next one of the waists. The body ends at the distal end with a horn having a flared edge forming a lip to enter in contact with items to be handled by the system for sorting materials.

### CROSS-REFERENCE TO RELATED APPLICATIONS

This application is a continuation-in-part of U.S. Ser. No. 17/605,277 filed Oct. 21, 2021, which is a national-phase application from PCT/CA2020/051036 filed Jul. 29, 2020, which claims priority from U.S. provisional patent application No. 62/879,880 filed Jul. 29, 2019, the specification of which is hereby incorporated by reference.

### FIELD

The subject matter disclosed generally relates to a sorting system for sorting materials, such as recyclable materials or construction materials. More specifically, it relates to a suction tool for a vacuum apparatus for selective handling in a sorting system.

### RELATED PRIOR ART

There are various systems designed for sorting materials, such as in the recycling industry. The sorting can be done in an automatic manner using optical means for recognizing particular types of objects on a conveyor, and using a handling tool to grab objects to be sorted.

Heterogeneity of the materials on the conveyor, both in terms of size and nature of the materials, makes the handling a difficult task. Performing this task further involves temporary stocking of such heterogenous materials, which is hard to manage in the industrial workflow. Improvements in the sorting systems need to address these issues.

In particular, the part of a system for sorting materials which grabs objects should be improved for greater efficiency in grabbing objects as well as facilitated maintenance and higher durability.

Prior art systems also notably use air-sucking systems which have small openings at the surface of contact with objects to be handled on a conveyor, for example of a diameter which is smaller than 0.75″, to avoid sucking up objects and ensure that th objects are properly handled on the conveyor without being sucked by accident inside the tubing of the air-sucking system.

### SUMMARY

According to an aspect, there is provided a system for sorting materials comprising:
a sorting apparatus comprising a handling tool and a robotized arm for displacing the handling tool over the materials; and
a vacuum apparatus creating a depression and having a tubing extending from a source for the depression to the handling tool where the tubing for the vacuum apparatus ends and where it defines a diameter;
wherein the handling tool is adapted to be displaced to a selected item among the materials and perform a contact therewith with the end of the tubing for the vacuum apparatus for, at least one of:
grabbing the selected item if the selected item is larger than the diameter; and
sucking up the selected item if the selected item is smaller than the diameter, wherein sucking up the selected item has the selected item travel through the tubing under the effect of the vacuum apparatus.

According to an embodiment, the system further comprises a decanter downstream of the source for the depression for receiving the selected item having travelled through the tubing.

According to an embodiment, the system further comprises a purge system operatively connected to the vacuum apparatus.

According to an embodiment, the purge system comprises an injection point for compressed air in the tubing between the decanter and the source for the depression for temporarily reducing vacuum to stop the materials being sucked up.

According to an embodiment, the purge system comprises a valve to shunt tubing by the injection point to further reduce vacuum to stop the materials being sucked up.

According to an embodiment, the purge system comprises a trap door at a bottom of the decanter which is operable to open simultaneously with an operation of the injection point for compressed air to purge the decanter while no materials fall into the decanter.

According to an embodiment, the tubing extending from a source for the depression to the handling tool comprises a plurality of ends each extending from a corresponding source for the depression being independent for each end, and ending at a same handling tool.

According to an embodiment, the system further comprises a conveyor under the handling tool for moving the materials to be sorted,

According to an embodiment, the tubing extending from a source for the depression to the handling tool comprises a tube end which performs the contact with the selected item, the tube end comprising a flexible portion for longitudinal contraction.

According to an embodiment, said flexible portion is a bellow, and the vacuum apparatus creating a depression and the bellow of the tube end are adapted to have the bellow contract sufficiently when the tube end performs the contact with the selected item to lift the selected item of a height at least as high as a height of the selected item for lifting above the conveyor.

According to an embodiment, the system further comprises another injection point for compressed air close to where the tubing for the vacuum apparatus ends for temporarily reducing vacuum to stop the materials being sucked up and to unclog said portion of the tubing.

According to another aspect, there is provided a method for sorting materials comprising:
conveying materials among which an item is to be sorted;
selecting the item for removal from the conveyed materials;
displacing a handling tool onto the item;
performing a vacuum at a vacuum tube end within the handling tool, thereby grabbing said item by suction if the item is larger than the vacuum tube end or sucking up the item through the vacuum tube end if the item is smaller than the vacuum tube end.

According to an embodiment, the method further comprises providing a vacuum source and a decanter upstream of the vacuum source.

According to an embodiment, the method further comprises purging the item sucked up through the vacuum tube.

According to an embodiment, purging comprises injecting compressed air in tubing between the decanter and the vacuum source for temporarily reducing the vacuum to stop the materials being sucked up.

According to an embodiment, the step of injecting compressed air in tubing between the decanter and the vacuum source for temporarily reducing the vacuum to purge the decanter also performs a pressure cleaning of a filter located by the decanter in direction of the vacuum source.

According to an embodiment, purging comprises shunting the tubing by the injection point to further reduce vacuum to stop the materials being sucked up.

According to an embodiment, when grabbing said item by suction, a vacuum is continuously applied and wherein the step of grabbing comprises grabbing with a flexible bellow, such that when the vacuum is continuously applied, the bellow contracts longitudinally to lift the item above the conveyor.

According to an embodiment, the method further comprises injecting compressed air at another injection close to the vacuum tube end for temporarily reducing vacuum to stop the materials being sucked up and to unclog said portion of the tubing.

According to an aspect of the disclosure, there is provided a suction tool for a system for sorting materials with a vacuum tube, the suction tool comprising: a body of flexible material wall to be installed at a distal end of the vacuum tube and forming a tubular wall, the tubular wall being shaped with alternating rims and waists, and from a proximal end of the suction tool to a distal end thereof; an average diameter increasing proximally over a length of the body of flexible material.

According to an embodiment, each rim has a local rim diameter larger than a local waist diameter of a next adjacent one of the waists.

According to an embodiment, each rim has a local rim diameter larger than a local waist diameter of a next adjacent one of the waists, toward a proximal direction, by a difference between about 1.0″ and 1.8″.

According to an embodiment, the average diameter increasing proximally over the length of the body of flexible material is implemented by having each rim having said local rim diameter larger the local rim diameter of a next one of the rims; each waist having said local waist diameter larger the local waist diameter of a next one of the waists.

According to an embodiment, each rim has said local rim diameter between about 0.29″ and about 0.45″ larger the local rim diameter of a next one of the rims, a smallest one of the local rim diameter being between about 2.8″ and about 3.0″.

According to an embodiment, each waist has said local waist diameter between about 0.15″ and about 0.27″ larger the local waist diameter of a next one of the waists, a smallest one of the local waist diameter being between about 1.0″ and about 2.0″.

According to an embodiment, the body ends at the distal end with a horn having a flared edge forming a lip to enter in contact with items to be handled by the system for sorting materials.

According to an embodiment, the body is integrally made of a single piece.

According to an embodiment, the body is made of rubber.

According to an embodiment, the body is made of neoprene.

According to an embodiment, the body has a Shore A hardness between about 45 and about 55.

According to another aspect of the disclosure, there is provided a suction tool for a system for sorting materials with a vacuum tube, the suction tool comprising:
a body of flexible material wall to be installed at a distal end of the vacuum tube and forming a tubular wall, the tubular wall being shaped a succession of stages which are integrally formed with each other in a single piece, with alternating rims and waists, each pair of a rim and waist and connecting wall in between defining one of the stages, and from a proximal end of the suction tool to a distal end thereof; each one of the stages is larger than a next adjacent one of the stages.

According to an embodiment, each rim has a local rim diameter larger than a local waist diameter of a next adjacent one of the waists within a same stage.

According to an embodiment, the rim of each stage is between about 0.75″ and 1.1″ larger in diameter than the rim of a next adjacent one of the stages.

According to an embodiment, the rim of each stage has said is between about 0.30″ and about 0.45″ larger the rim of a next one of the stages, a smallest one of the rims being between about 2.8″ and about 3.0″.

According to an embodiment, the rim of each stage has said is between about 0.15″ and about 0.27″ larger the rim of a next one of the stages, a smallest one of the rims being between about 1.8″ and about 2.0″.

According to an embodiment, the body ends at the distal end with a horn having a flared edge forming a lip to enter in contact with items to be handled by the system for sorting materials.

According to an embodiment, the body is made of rubber.

According to an embodiment, the body is made of neoprene.

According to an embodiment, the body has a Shore A hardness between about 45 and about 55.

### BRIEF DESCRIPTION OF THE DRAWINGS

Further features and advantages of the present disclosure will become apparent from the following detailed description, taken in combination with the appended drawings, in which:

FIG. 1 is a perspective view illustrating an apparatus for sorting materials, according to an embodiment of the invention;

FIG. 2 is a perspective view illustrating a sorting device in the apparatus for sorting materials, according to an embodiment of the invention;

FIG. 3 is a perspective view illustrating a cyclonic decanter for the apparatus for sorting materials, according to an embodiment of the invention;

FIG. 4 is a flowchart illustrating the components of the system for sorting materials, according to an embodiment of the invention;

FIG. 5 is a schematic diagram illustrating the system for sorting materials, according to an embodiment of the invention;

FIG. 6 is a flowchart illustrating a method for sorting materials, according to an embodiment of the invention;

FIG. 7 is a perspective view illustrating an apparatus for sorting materials, according to an embodiment of the invention;

FIGS. 8A-8D are a side contextual view, a perspective view, a cross-section and another perspective view illustrating a suction tool for an apparatus for sorting materials, according to an embodiment of the invention;

FIGS. 9A-9B are a perspective view and a cross-section illustrating a suction tool for an apparatus for sorting materials, according to another embodiment of the invention;

FIGS. 10A-10B are side views illustrating a flexible body of the suction tool of FIG. 9A; and

FIG. 11 is a perspective view illustrating the suction tool as in FIG. 9A.

It will be noted that throughout the appended drawings, like features are identified by like reference numerals.

### DETAILED DESCRIPTION

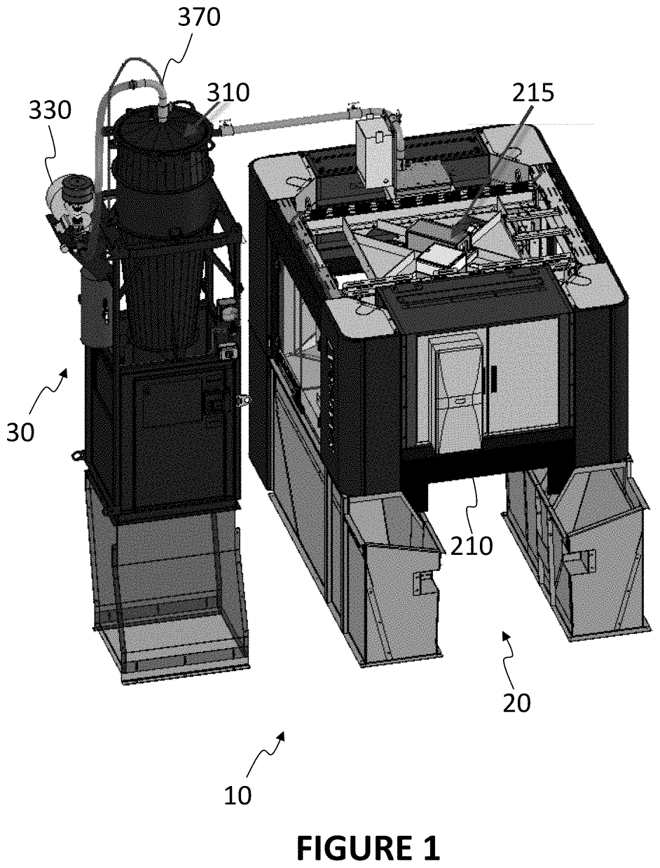

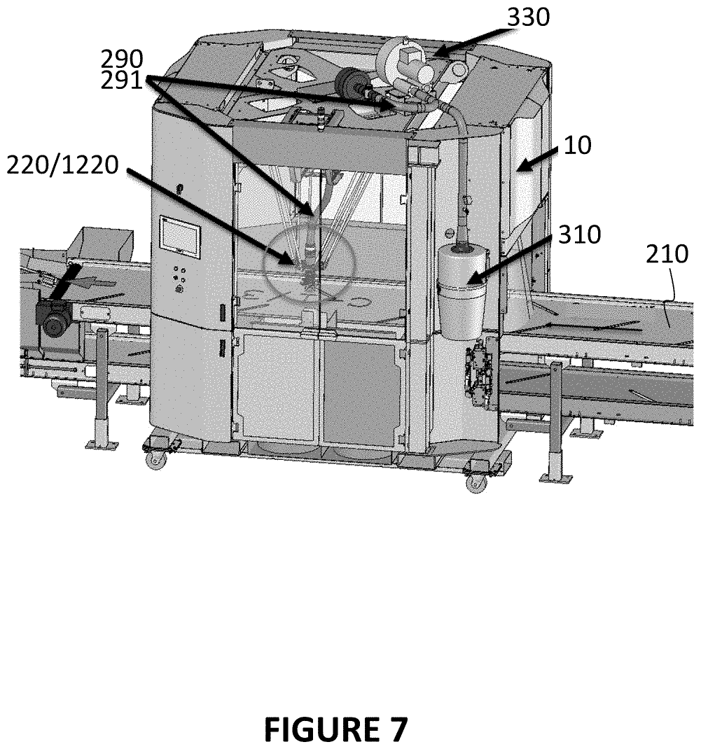

Referring to FIG. 1 or FIG. 7, there is shown a system 10 for sorting materials undergoing a movement, such as on a running conveyor. The system 10 according to an embodiment of the invention comprises a sorting apparatus 20 and a vacuum apparatus 30 in combination therewith. The sorting apparatus 20 comprises a conveyor 210 on which the materials (comprising individual items to be sorted) are transported, or any other mechanism by which the materials to be sorted are being moved for the purpose of performing selective picking during said movement, the movement permitting a high frequency for this selective picking. The sorting apparatus 20 is adapted to perform real-time identification of the items transported thereon in view of the selective picking.

A handling tool 220, or head, is provided and is used to grab and handle selected large items on the conveyor 210, or alternatively to suck up selected small items away from the conveyor 210, depending on a real-time identification made immediately before the grabbing or the sucking action. The handling tool 220 is robotized, so that the handling tool 220 is directed right above the expected location of the selected items on the moving conveyor 210 (or any other moving mechanism), and the handling tool 220 can grab the item for removal from the conveyor 210 and displacement to another location (e.g., into a dedicated container, onto another conveyor, onto a specific location on the floor, etc.).

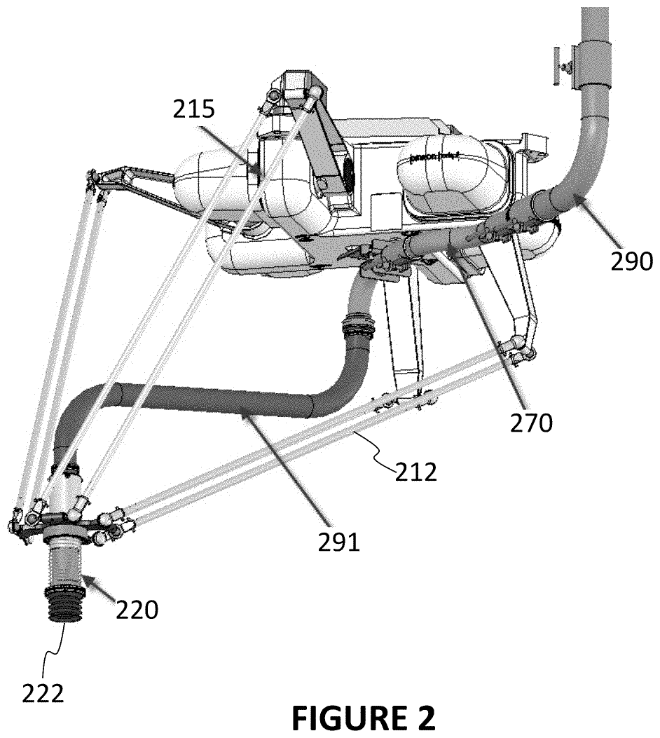

The sorting apparatus 20 comprises a mechanism to displace the handling tool 220 by robotized translation of the handling tool 220 over the conveyor 210, for example arms 212, which are shown in FIG. 2. These arms 212 are expected to extend from a gantry or another static location above the conveyor, and are robotized be able to translate the handling tool 220 at the location where the items to be grabbed or sucked up are to be located at the end of the movement of the handling tool 220 (i.e., the time taken for the robotized translation and the movement of the item over the conveyor 210 during this time interval should be taken into account when the robotized movement is instructed). Items are identified using appropriate optical equipment 214, which can comprise cameras using image recognition, or other tools involving spectrometry (i.e., with a light source where the reflected light is analyzed) and the like to identify the nature of the items to grab or suck up, in particular the nature of the object (to decide whether to act on it or not) and the position where the handling tool 220 should be displaced to act on it. The result is that a given item to remove will be either grabbed or sucked up, depending on its size relative to the diameter of the tubing, or not acted upon depending on the nature of the item, as described further below.

The device which controls the arms 212 and which receives data from the optical equipment 214 is generically called the sorting robot 215, which can comprise a controller 300 for the system 10, or be operatively connected to such a controller 300, which receives and treats data to perform the tasks in the system 10.

According to an embodiment of the invention, the handling tool 220 comprises a vacuum tube end or suction tool 222 or 1222, described more specifically further below, formed by a wall with a generally cylindrical or frustoconical shape and additionally shaped with alternating rims (or ridges) and waists, defining a tube with an inside passage therethrough (lumen). Such a vacuum tube end or suction tool 222 for the handling tool 220 is advantageous to provide a double functionality of either grabbing large items by suction, thereby acting like a suction cup, or sucking up small items away to perform vacuum cleaning. It should be noted that an alternative embodiment for the vacuum tube end or suction tool 222 is also described further below. To this end, there is provided a vacuum tubing 290, which extends from the handling tool 220, where it has its vacuum entry point, to a decanter 310, where it has its exit point. The vacuum tubing 290 performs the vacuum cleaning by removal of small items through the tubing, captured by the low pressure which draw them away and moves them through the vacuum tubing 290 toward the source of vacuum, and also performs the static suction by providing a tubing where a vacuum is made when the end (vacuum entry point) is obstructed by the large item to be sucked the large item being statically held there by suction.

In that particular case, the handling tool 220 is well adapted to vacuum clean (i.e., remove) the small items among the materials on the conveyor 210. The implication is that small items can be identified, so that the handling tool 220 is directed (i.e., instructed and moved by the controller) right above the expected location of these items on the moving conveyor 210 (i.e., expected location by the end of the movement of the handling tool 220), and the vacuum will suck up the small items away from the conveyor 210, using the vacuum tubing 290, to remove such small items from the conveyor 210. The assumption here is that small items usually need to be removed as they are either valuable materials that need to be collected, undesirable debris that need to be removed, or materials that need to be put in a single place for any other reason, whether the materials being sorted are for recycling, construction, or other industrial processes. The expression “small items” may also refer to items which are not necessarily small, but are flexible or deformable such as to be suckable by the tubing. An example of such deformable or flexible items that fit inside the diameter of the tubing 290 can include consumer plastic bags.

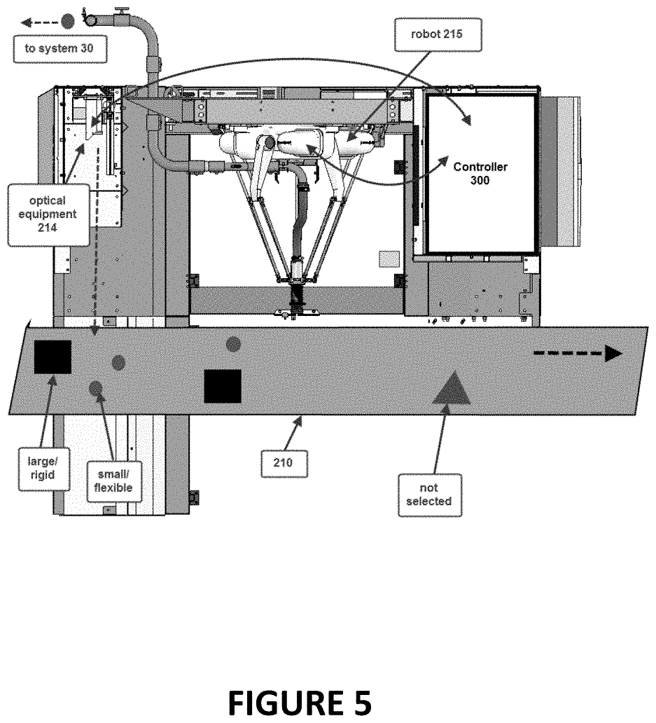

FIG. 5 illustrates the materials on the conveyor 210, including small and large items with a differentiated treatment (i.e., selective sorting).

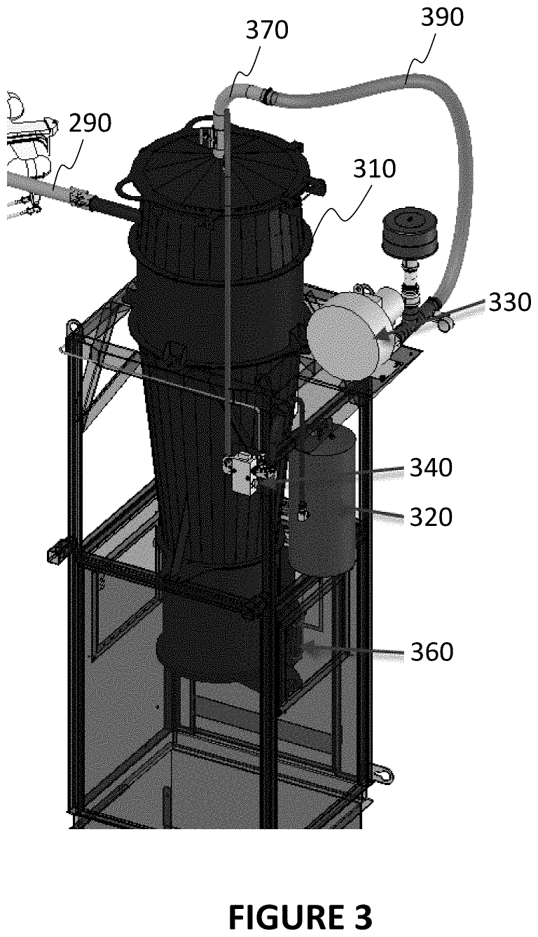

According to an embodiment, and as shown in FIG. 1 and, more clearly, in FIG. 3, the decanter 310 is a cyclonic decanter, which uses a rotary movement of the volume of air containing particles in suspension therein to filter said particles (i.e., the small items) from said volume of air by having them fall down into the container of the decanter 310, while leaving the cleaned volume of air flow upwardly. The decanter 310, when embodied as a cyclonic decanter, is typically a single container with an upper portion shaped as a cone in which the entering air flows in a tangential direction along the conical surface to separate particles (which fall down) and air (which flows up). After a continuous use of the system 10, it should be expected that the decanter 310 fills up with the small items or particles accumulating therein.

Considering that the vacuum tube end 222 is upstream, there is defined another location downstream of the decanter 310, a vacuum fan motor 330 (at the most downstream location in the path) that creates the necessary depression (pressure gradient) between itself and the decanter. Tubing 390, extending between the decanter 310 and the vacuum fan motor 330, connects them to perform the vacuum function by significantly decreasing the pressure in the decanter 310 and by keeping it low during operation. It should however be noted that the vacuum fan motor 330 that creates the necessary depression can be located elsewhere in the system 10, for example within the tubing 290 (therefore, upstream of the decanter 310 or of any other item depository), as long as the sucked items can keep moving into the tubing 290, for example using their momentum to keep moving past the vacuum fan motor 330 toward the decanter 310, or fall within the tubing 290 under the force of gravity for example. Overall, there should be produced a significant air flow in the system 10, effective at the suction tool 222 or 1222, which can be used to lift objects for either simple static grabbing or dynamic ingestion of the objects into and through the system 10, despite the suction tool 222 or 1222 not having a perfect adhesion or not well conforming to the surface of the object.

In order to achieve the double function of grabbing large items by static suction at the tube end and sucking up small items through the lumen of the tubing for vacuum cleaning, the depression created by the vacuum fan motor 330 (acting as a source of depression for the vacuum function) should be in the order of 40 inches of water or above, such as between 40 and 80 inches of water, preferably between 50 and 80 inches of water, and more preferably about 70 inches of water. An inch of water is the typical unit measurement in this field and it is equivalent to 248.84 Pa.

The vacuum tube end or suction tool 222 (described in greater detail further below, where an alternative embodiment of a vacuum tube end or suction tool 1222 is also described) is expected to be the end of a tube and therefore is expected to have a substantially circular opening. The diameter of this circular opening should be chosen to fit the desired threshold which defines which items are being grabbed and which items are being sucked up, and therefore depends on the application. Such a diameter can range between 0.5″ to 8″, for example about 2″. Items larger than this diameter or threshold are expected to be grabbed, while those smaller are expected to be sucked up through the tubing 290, downstream toward the decanter 310.

After a significant period of time of operating the system 10, the decanter 310 will slowly fill up and the system 10 will become less efficient. In a typical work flow, the system 10 would need to be stopped completely to empty the decanter and clean it. This is a normal maintenance task, but it implies stopping the apparatus, which is not efficient.

According to an embodiment of the invention, there is provided a cleaning tool and method of operation thereof which allows emptying and purging the decanter 310 and avoiding turning the system 10 off. A compressed air source 320 is provided. The compressed air source 320 connects to a compressed air injection point 370 in the vacuum tubing 390.

According to an embodiment of the invention, the compressed air injection point 370 is located between the vacuum fan motor 330 and the decanter 310. The injection point 370 can otherwise be located at other places in the system 10 as long as the result is a significant decrease in the depression that is measured at the vacuum tube end 222.

According to another exemplary embodiment, the injection point 370 can be replaced by a valve that shuts the tubing to effectively cease the depression from reaching the vacuum tube end 222.

A valve 340 is located between the compressed air source 320 and the compressed air injection point 370 to act as a logical gate which lets compressed air into the tubing 390 to perform the purge. The valve is controlled by a controller 300, such as the computer controlling the system 10, which instructs the valve 340 to open when the purge is to be performed.

This purge can be performed periodically according to some rules. For example, it can be performed after a definite period of time operating the system 10, or after a given number of items sucked up through the handling tool 220, or after a given volume of material that was sucked up, or after a given height of small items in the decanter 310, using in each case the appropriate detector.

The injection of compressed air has the effect of counter-balancing the vacuum from the vacuum fan motor 330 to reduce significantly or cancel the pressure gradient between the decanter 310 and the vacuum tube end 222 (or 1222). Injected compressed air flows toward the vacuum fan motor 330 that created the depression and thereby stops the air flow from flowing toward the decanter 310. The overall effect in the tubing 290 is to stop the vacuum at the level of the handling tool 220 and to stop inflow of materials into the decanter 310.

Once the injection has started, the controller 300 can instruct the opening of a trap door 360 below the decanter 310, or any other suitable means for emptying the decanter 310 by timing this operation with the injection of compressed air (i.e., the opening of the trap is simultaneous with the injection of compressed air which momentarily stops the vacuum mode of operation of the apparatus). This can be performed in a few seconds, for example by maintaining the injection of compressed air in the tubing for a given period of time between 2 and 4 seconds. During this time, the injection of compressed air in the tubing under vacuum operation reduces the pressure gradient, below a threshold where small items cannot be sucked up anymore, and thereby stops the flow of air and small items into the decanter 310. The injection and its effect is almost instantaneous and this is why the purge can be performed so fast and easily without having to stop and restart the vacuum fan motor 330, which would take longer to do. Once this is done, the trap is closed again and the purged decanted is ready for operation again. The controller 300 can therefore instructs the valve 340 to close to stop injection of compressed air and restart the normal vacuum mode of the handling tool 220.

Moreover, this injection of compressed air can advantageously clean the filter at the exit of the tubing/entry of the decanter 310 because the injected compressed air is directed toward the entry of the decanter 310, that it reaches with high pressure and velocity against the normal flow direction (being normally from the decanter 310 to the vacuum fan motor 330 while the compressed air being injected within the same tubing travels to the decanter 310) and can perform a mechanical action of cleaning the filter by flowing therethrough in the reverse direction.

In order to actuate the opening of the trap door 360, there may be provided a pneumatic cylinder, a hydraulic cylinder, or any other type of servomotor which can actuate a hinge or a similar device that opens a door, as instructed by the controller in synchronicity with the injection of compressed air.

This process ensures that the purge of the decanter 310 is performed in about 3 seconds. This procedure is almost seamless and does not hamper the operation of the system 10.

According to another embodiment, the decanter 310 can be replaced by a chopper-blower to separate the small items, or flexible items (e.g., plastic bags) from the air that has been drawn thereinto.

According to another embodiment, the decanter 310 can be replaced by, or comprise therein, a screw compactor to separate the small items, or flexible items from the air that has been drawn thereinto, or to compact or withdraw materials. An endless screw compactor inside the decanter 310 would therefore act as a purge system therefor, and can be operated continuously to provide a continuous purge.

According to another embodiment, the decanter 310 can have no bottom (i.e., no cyclonic decanter in the system 10) such that the sucked up small items fall onto the floor at a dedicated location. This alternative embodiment removes the requirement of a trap and of the injection of compressed air. In that case, it is likely that the vacuum fan motor 330 that creates the necessary depression will be located upstream of that dedicated location. In this case, as already mentioned above, the sucked items should keep moving into the tubing 290, for example using their momentum to keep moving past the vacuum fan motor 330 toward their final destination, or fall within the remaining parts of the tubing 290 under the force of gravity for example. This case in which there is no decanter, and having the vacuum fan motor 330 upstream of the final destination of the sucked items, can be referred to as an automatic, continuous purge system. Advantageously, there is no constrained limit on the volume of those items that can be captured (i.e., as large as the facility can allow, but not constrained by a container size).

According to an embodiment, there is provided another injection point 270 closer to the handling tool 220, i.e., between the handling tool 220 and the decanter 310. This compressed air, when injected, has the effect of cancelling the depression directly at the level of the handling tool 220. This is useful to release a large item that was grabbed by the handling tool 220 using suction, the release being performed instantaneously as the compressed air is injected in tubing close to the handling tool.

As mentioned above with respect to the injection point 370, a valve or any other suitable mechanism that shuts the tubing to effectively cease the depression from reaching the vacuum tube end 222 (or 1222) can be added between the decanter 310 and the injection point 270, to reduce flow or, equivalently, pressure at the injection point 270.

Indeed, when a large item is grabbed by the handling tool 220, it is not sucked up away through the tubing 290 as described with respect to the small items. It is instead captured, under the effect of static suction provided by the pressure gradient, by the handling tool 220, which can lift up the item as long as the depression generated by the vacuum fan motor is sufficient for the weight of the large item (and taking into account that the shape of the object may not fit perfectly the vacuum tube end or suction tool 222 or 1222, as described below, in which case higher pressure gradients may be necessary to keep holding the large item). According to an embodiment, the tubing 290 comprises a flexible portion 291 which can adapt to the robotized movement of the handling tool 220. Moreover, when a large item is grabbed, a larger depression (i.e., pressure difference) is temporarily created within the tubing 290 as the vacuum fan motor 330 keeps running while there is no more air inflow from the vacuum tube end 222 or 1222, and the handling tool 220 deforms and contracts on itself, which has the effect of naturally lifting the end of the handling tool 220 and the grabbed item altogether along with the deformation of the handling tool 220 as a consequent result of the pressure gradient buildup following the grabbing action. The handling tool 220 can therefore be provided advantageously with a resilient material forming a bellow, as shown in FIG. 2, or any other shape the deforms such as to be contracted longitudinally. This lift movement brings the grabbed item up, away from the other materials on the conveyor, the handling tool 220 can therefore be translated horizontally to bring the item elsewhere. To release the large item, injection of air in the injection point 270, for example immediately downstream of the flexible portion 291, cancels the depression, thereby eliminating the suction by which the item is grabbed and effectively releasing it under gravity. To avoid the whole tubing 290 to undergo deformations, the tubing 290 can be rigid, but for the flexible portion close to the handling tool 220, and the handling tool 220 should be deformable in longitudinal compression to undergo the contraction movement due to the pressure gradient buildup during grabbing. For a proper lift, the contraction of the bellow at the end of the tubing 290 should be at least as high as the height of the large objects on the conveyor for lateral displacement and release of the object being grabbed,

The depression ranges described above are chosen to be sufficient to provide the necessary suction airflow to be able to grab items which have an irregular surface. For example, items with a large surface are grabbed by having the suction tool 222 or 1222 enter in contact with the surface and form a suction grabber. If the surface is irregular, the contact may not be good, and air may still pass through interstices between the vacuum tube end or suction tool 222/1222 and the item's surface. Having a large depression in the vacuum system 30 ensures that the item will still be grabbed despite the imperfect contact of the vacuum tube end or suction tool 222/1222 with its surface. Otherwise, providing the vacuum tube end or suction tool 222/1222 with a resilient material such as rubber or an equivalent thereof may help in providing an efficient suction cup effect for grabbing.

The injection of compressed air at the injection point 270 further provides a mean for unclogging the tubing, should there be any materials stuck therein, especially close to the handling tool 220, due to a misclassification of an item as being a small item where it should not have entered the tubing in the first place.

According to an embodiment, the injection points 270 or 370 comprise a specific internal shape of the tubing which ensures that the injection of compressed air is efficient to compensate for the depression and thereby cancel the vacuum. For example, the tube may be shaped as a sequence of two consecutive elbows (e.g., 45° elbows) in the tubing, creating an obstacle for the airflow in the tubing 290 or 390, with the point of injection 270 or 370 being a nozzle ending at the center of the lumen of the tube between these elbows. This geometry improves the effectiveness of vacuum cancelation, whether for the release of the grabbed item at the handling tool 220 or for purging the decanter 310.

According to an embodiment, the handling tool 220, or head, can comprise more than one vacuum tube end or suction tool 222, for example two tube ends, one being for grabbing items and the other being for sucking items away. The tubing 290 can comprise a corresponding number of tubes, or the tube can split to form the more than one vacuum tube end or suction tool 222/1222. In other words, if the moving the head comprises more than one end, the plurality of ends can have their vacuum generated by the same blower (i.e., the same vacuum fan motor 330) or by a corresponding plurality of motors, or any combination. The pressure can be set to be the same in all ends of the head, or an be set at different pressures, which would imply a selective removal of small items and grabbing of large items depending on the size and weight, i.e., each tube end does not suck or grab the same things due to different pressures in their tubing (only a large depression can be used on heavier items). The controller 300 may then decide which tube end among the plurality is the most appropriate for a specific sucking or grabbing task to be performed. The robot 215 can move all the tube ends or, alternatively, different robots may be used for the plurality of tube ends.

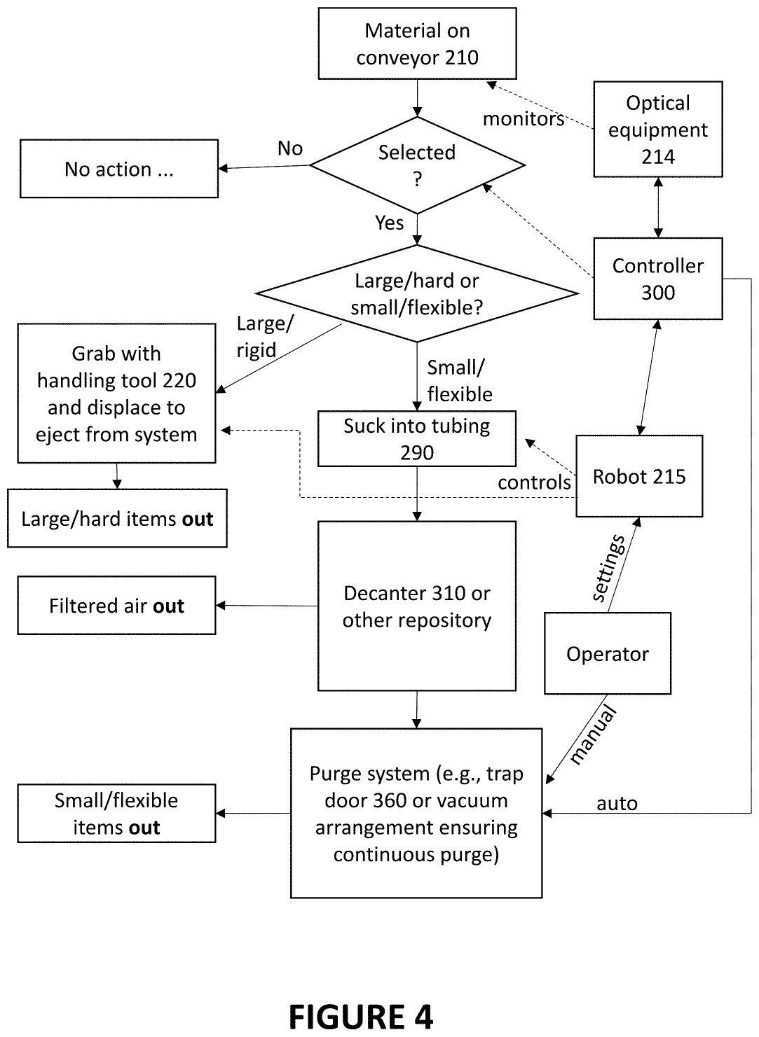

FIG. 4 illustrates that the material on the conveyor 210 are selected or not. Those not selected remain on the conveyor. Those which are selected by the optical equipment 214 are classified as a large or small (or hard or flexible), and are grabbed or sucked accordingly, these operations being controlled by the sorting robot 215. Sucking small or flexible items (or any other type which fits inside the tubing 290 or deforms to fit thereinto) results in them ending up in the decanter 310 or other free repository, and are purged. The purge can be operated manually by the operator, or automatically by the controller 300. The purge can involve opening the decanter 310 using a door, or can instead involve having the vacuum fan motor 330 located upstream of the repository of small items such that the vacuum operation on those small items also includes a continuous and automatic purge. The purge system can therefore comprise either the trap door 360 along with the injection point 370 and other associated equipment, or it can relate to the arrangement (vacuum motor fan upstream of the final destination of the small items) that makes possible the continuous purge, or to any other device described herein such as an endless screw or a chopper-blower, for example.

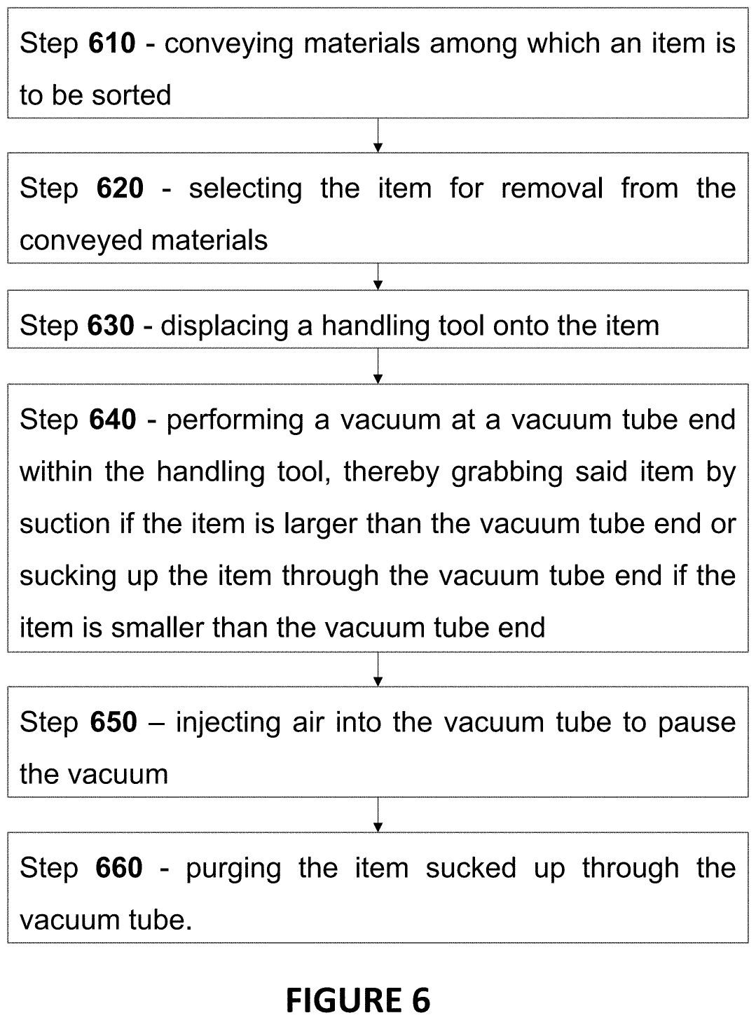

FIG. 6 is a flowchart which summarizes the method for sorting materials and comprises the following steps.

Step 610—conveying materials among which an item is to be sorted;

Step 620—selecting the item for removal from the conveyed materials;

Step 630—displacing a handling tool onto the item;

Step 640—performing a vacuum at a vacuum tube end within the handling tool, thereby grabbing said item by suction if the item is larger than the vacuum tube end or sucking up the item through the vacuum tube end if the item is smaller than the vacuum tube end;

Step 650—injecting air into the vacuum tube to pause the vacuum; and

Step 660—purging the item sucked up through the vacuum tube.

There is now discussed the handling tool 220 in greater detail, including in particular the vacuum tube end or suction tool 222. The terms the “vacuum tube end” and “suction tool” are used interchangeably, because the vacuum tube end is expected to enter in contact with the objects to grab and thereby act as a grabbing or removal tool using the suction effect resulting from the suction cup design coupled to a source of a partial vacuum.

The handling tool 220, which grabs or sucks up objects using the suction tool 222/1222, undergoes significant forces, both in torsion (shearing forces) and in compression. The handling tool 220 may be actuated to grab or suck up an object at a frequency which is expected to be between 60 and 120 occurrences per minute, including a vertical displacement of the handling tool 220, involving the displacement of the grabbed object, and a mechanical shock resulting from the contact with objects or with the conveyor and with the reaction from the release of said object.

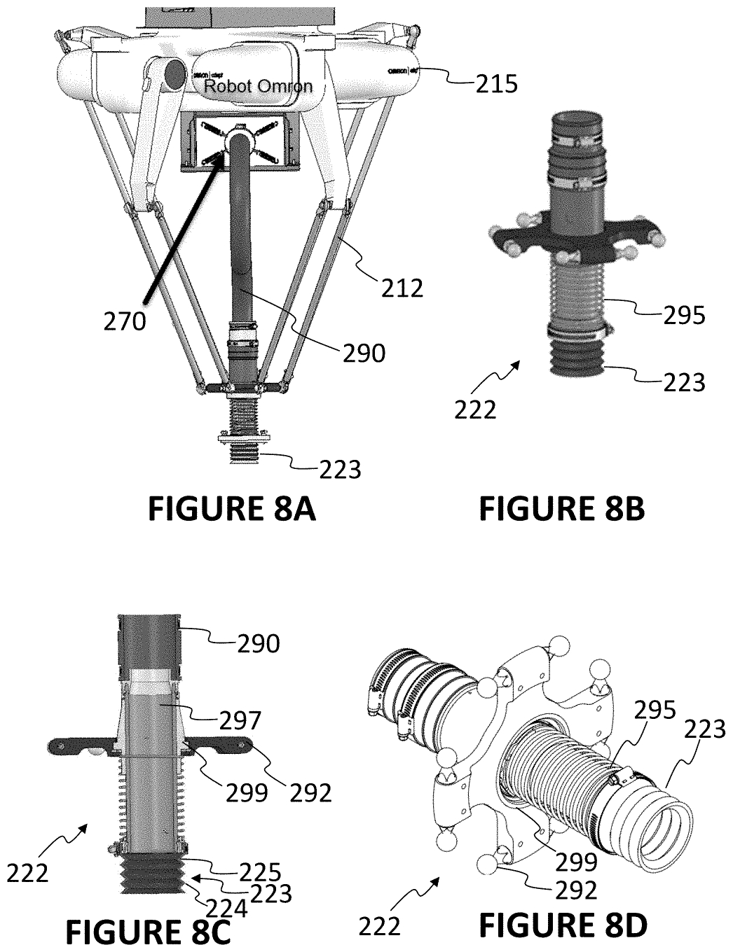

FIG. 8A-8D specifically illustrate the vacuum tube end or suction tool 222 according to a first embodiment of the present disclosure. According to this first embodiment of the vacuum tube end or suction tool 222, the suction tool 222 comprises a flexible body 223, integrally made of a single piece of material which is flexible, and which is formed of a succession of rims 224 (large or outer diameter, also known as a ridge) and waists 225 (minimum diameter within a tube having a local diameter reduction thereon). Thereby, the flexible body 223 has a shape which is similar to a bellow or accordion, with a succession of partial folds defining the rims (outer or larger diameter) and the waists (inner or smaller diameter). This shape is straight on the outside, i.e., all rims have the same diameter (namely: rim diameter) and all waists have the same diameter (namely: waist diameter), and therefore the flexible body 223 generally has a shape which resembles a cylinder, taking into account the bellow configuration. By definition, the rim diameter is larger than the waist diameter. The shape of the flexible body 223 is made (for example by molding the flexible body 223 during fabrication) to alternately fold inwardly and outwardly at specific locations to define said rims and waists in an alternate fashion.

According to an embodiment of the disclosure, the flexible body 223 is made of an elastomer. According to a more specific embodiment of the disclosure, the flexible body 223 is made of urethane.

The cross-section of the flexible body 223 along a horizontal plane should show that the flexible body 223 is locally a circle. When considered longitudinally, the flexible body 223 is formed of a circle which has a varying diameter alternately ranging from the (maximum) rim diameter and the (minimum) waist diameter, and varying linearly in between.

Folds in the flexible material (at the trim and waist) provide some rigidity to the flexible body, while the flat, inclined planes between the rims and waists, which are technically in the shape of a truncated cone between each rim and adjacent waist, are more flexible. The overall effect is a flexible body 223 having some flexibility and generally maintaining its shape.

As well shown in FIG. 8C, according to an embodiment of the disclosure, the flexible body 223 can have 5 rims, interspaced with 4 waists. The most distal rim can be named as the lip, as it enters in contact with the objects to be grabbed. The thickness of the flexible body 223 can be substantially constant along its length. A small variation in thickness can be expected at the rims and waists, or at the lip.

In order to increase the ability to undergo a vertical translation for the handling tool 220, as described above, there can be provided a spring connector 295. The spring connector 295 is a sleeve formed with a spring which can either compress or extend depending on the forces being exerted within the handling tool 220, i.e., when a large object is being contacted and grabbed, the vacuum is more pronounced, the tubing 290 is induced to retract and the handling tool 220 moves up. This moving up of the handling tool 220 is made more pronounced by having the spring connector 295 be able to compress for additional retraction upwardly.

The most proximal rim of the flexible body 223 can be attached to the spring connector 295, as shown in FIG. 8C, for example with a collar as shown in FIG. 8B. To implement the ability of the flexible body 223 to retract (translate) with an amplitude greater than that of the tubing 290, the spring connector 295 should connect between the flexible body 223 and the tubing 290. A tubing connector 299 is thereby provided, such that the spring connector 295, at its distal end, connects to the most proximal portion of the flexible body 223 (e.g., most proximal rim) and, at its proximal end, to the tubing connector 299 of the tubing 290.

In order to ensure that the vacuum effect is well transmitted into the inside (lumen) of the flexible body 223 despite the spring connector 295 between the flexible body 223 and the tubing 290, an inner vacuum sleeve 297 is provided and acts as a slidable piston. The inner vacuum sleeve 297 is housed within both a distal portion of the tubing 290 (can be inwardly tapered therein) and within the spring connector 295 which surrounds it. The inner vacuum sleeve 297 should therefore start from inside the tubing 290 to act as a mobile, slidable extender for the tubing 290 within the spring connector 295, and should also reach the flexible body 223 and be secured therewith. In other words, it should connect with a proximal portion of the flexible body 223 to undergo the same level of translation during operation as the flexible body 223. The inner vacuum sleeve 297 may provide some buffering of the movement of translation to amortize mechanical shocks. For example and without limitation, FIGS. 8B and 8C may illustrate different embodiments. In FIG. 8B, the inner vacuum sleeve 297 may slide within the tubing connector 299, and the spring 295 can compress while the parts located above the tubing connector 299 can be stationary (not moving). In FIG. 8C, the inner vacuum sleeve 297 may slide within the tubing connector 299, and the the parts located above the tubing connector 299 can move along with the inner vacuum sleeve 297 (not stationary in this case).

Handles 292 can be added to the tubing connector 299, as shown in FIGS. 8A-8D. In particular, the handles 292 can be used to pivotally attach the distal ends of the arms 212, which are described above in reference to FIG. 2.

Since the objects on the conveyor often include fine particulate matter, dust and other glass or plastic granules, such matter often gets stuck in small interstices, cracks and other geometrical features of the handling tool 220. A very regular maintenance schedule needs to be observed, especially to avoid any blocking of the sliding parts or translating parts. Also, this configuration with sliding portions in translation with respect to other parts may simply break if the handling tool hits a large object on the conveyor, requiring a costly part replacement as well as downtime for the system 20.

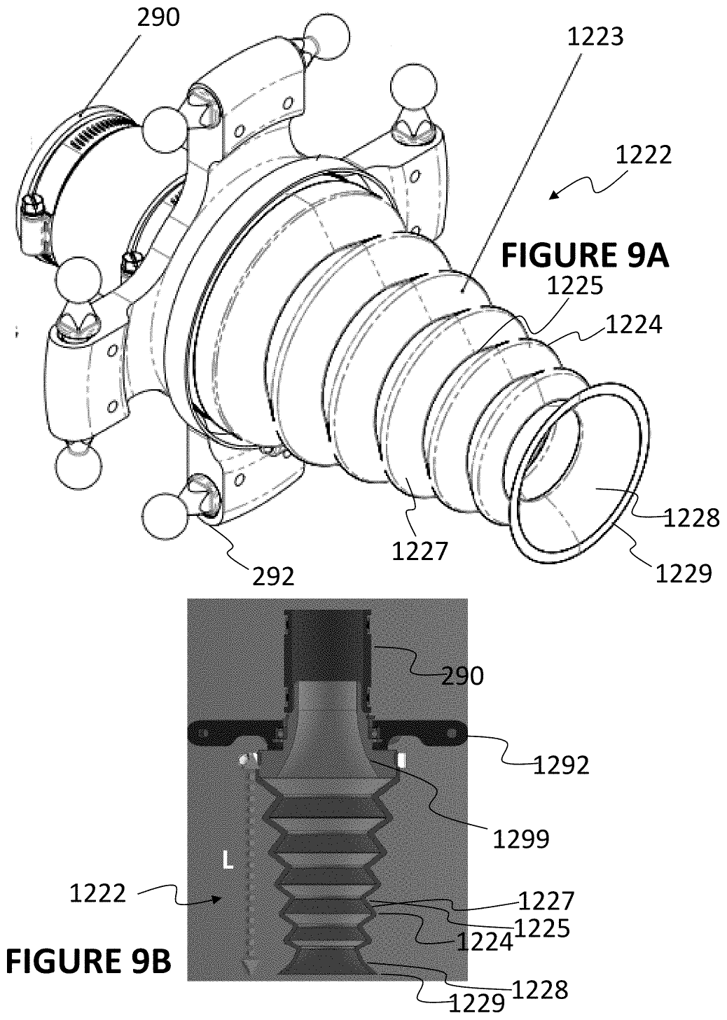

Accordingly, to address these issues, there is presented below a second embodiment for the vacuum tube end or suction tool, now referred to with the reference number 1222, as a part of the handling tool 220. FIGS. 9A-11 illustrate the vacuum tube end or suction tool 1222 according to this second embodiment of the present disclosure.

Using a succession of alternating rims and waists with an average diameter decreasing in the distal direction, and other adequate geometrical features as described further below, the suction tool 1222 is made self-retractable and is more amply compressible. This can make the suction tool 1222 sufficient for significant retractation and lift objects on the conveyor without the need for other sliding or moving portions in the handling tool 220. This also significantly reduce the movement of the tubing 290 itself and therefor of the arms 212 of the robot, since most of the amplitude of retraction is obtained by the longitudinal deformation of the suction tool 1222 (where said arms 212 can be made of carbon fiber and subject to breaking when undergoing large forces), which implies a lesser frequency and intensity of vibrations on the robot (which needs recalibration when undergoing too much vibration), and greater rapidity.

According to this second embodiment of the vacuum tube end or suction tool 1222, the suction tool 1222 comprises a flexible body 1223, integrally made of a single piece of material which is flexible, and which is formed of a succession of alternating rims and waists of a decreasing diameter along the length of the flexible body 1223 (tapered shape, or shape of a truncated cone). Thereby, the flexible body 1223 has a shape which is similar to a bellow or accordion, with a succession of partial folds defining the rims (defining the outer diameter, which is a larger diameter than adjacent waist or waists) and the waists (inner diameter, which is a smaller diameter than adjacent rim or rims). This shape is decreasing in diameter, or tapered, on the outside, i.e., all rims do not have the same diameter and rather have a specific one (namely: local rim diameter) and all waists do not have the same diameter and rather have a specific one (namely: local waist diameter). Each rim should be adjacent to at least one and at most two waists. By definition, the local rim diameter is larger than the adjacent local waist diameter(s). The shape of the flexible body 1223 is made (for example by molding the flexible body 1223 during fabrication) to alternately fold inwardly and outwardly at specific locations to define said rims and waists in an alternate fashion. In view of the decreasing overall diameter over the length, each local rim diameter is larger than the next local rim diameter; and each local waist diameter is larger than the next local waist diameter, when going further distally toward the bottom, distal end of the suction tool 1222.

The material chosen to form the flexible body 1123 of the flexible suction tool 1222 should exhibit elastic properties and therefore can be selected to be an elastomer.

According to an embodiment, the flexible body 1123 of the flexible suction tool 1222 is a rubber. According to another embodiment, the flexible body 1123 of the flexible suction tool 1222 is a neoprene. The flexible body 1123 of the flexible suction tool 1222 can be fabricated by molding said rubber, neoprene, or other elastomer, into the shape as described comprises the succession of alternating larger rims and thinner waists following a distally decreasing diameter. The elastomer forming the flexible body 1123 of the flexible suction tool 1222 can be selected to have a Shore A hardness between about 40 and about 60, preferably between about 45 and about 55, and more preferable about 50.

The cross-section of the flexible body 1223 along a horizontal plane should show that the flexible body 1223 is locally an ellipse (including the particular case of a circle), or even a rectangle, giving the flexible body 1223 a general shape of a truncated cone (frustoconical shape) or truncated pyramid (frustopyramidal shape) before considering the bellow-like folds which add greater complexity to the exact shape. The frustoconical shape or frustopyramidal shape is used to increase the resistance to shearing forces (flexion) and make displacements more stable. When considered longitudinally, the flexible body 1223 is formed of a circle (or ellipse or rectangle) which has a varying diameter (or the ellipse's great axis or the rectangle's diagonal, not repeated throughout the text to ease reading but considered as an alternative) alternately ranging from the local rim diameter and the local adjacent waist diameter, and varying linearly in between, plus taking into consideration that the rim diameter and the waist diameter which succeed to each other distally (downwardly) are decreasing (i.e., getting smaller) along the length of the flexible body 1223 as the flexible body 1223 extends toward the horn and lip at the bottom distal end.

Bellow-like folds in the flexible material (at the trim and waist) provide some rigidity to the flexible body, while the flat, inclined planes between the rims and waists, which are technically in the shape of a truncated cone between each rim and adjacent waist, are more flexible. The overall effect is a flexible body 1223 having some flexibility and generally maintaining its shape. Also, having the successive rims having their local rim diameter decreasing over the length of the flexible body 1223, and the successive waists having their local waist diameter decreasing over the length of the flexible body 1223, ensures that the flexible body 1223 is much more capable of retracting according to its own longitudinal axis when a vacuum is applied therein (i.e., when the lip 1229 of the flexible body 1223 enters in contact with an object to grab it). Also, this greater flexibility reflects not only in the amplitude of retraction, but also in the ability to distort under shearing forces, which is higher in amplitude when compared to the embodiment of the flexible body 223 of FIGS. 8A-8D.

As well shown in Fig. C, according to an embodiment of the disclosure, the flexible body 1223 can have 6 rims 1224 (plus a distal horn 1228 ending with a lip 1229 which is analogous to a rim, as described below), interspaced with 5 waists 1225 (or 6 if the distal waist connecting to the horn 1228 is counted). The most distal rim can be named as the lip, as it enters in contact with the objects to be grabbed.

As mentioned above, the distal portion of the flexible body 1223 ends with a distal horn 1228 ending with a lip 1229 at the distalmost portion. The distal horn 1228 ending with a lip 1229 can be integral with all other stages forming the single-piece flexible body 1223. The horn 1228 has a tapered shape with the enlarging portion being directed distally toward the items to be grabbed, and ending with a lip 1229 which is the most distal rim and which enters in contact with the items to be grabbed. The inner diameter is the smallest diameter of the lumen of the flexible body 1223 and is chosen to act as a threshold to limit passage of large items and avoid that they block the tubing 290. The horn 1228 may have a venturi profile to ensure that the pressure differential is maintained and to aid in keeping the air flow high.

The horn 1228 is flexible enough thanks to it being made of a flexible material and also thanks to its shape of a horn with a naturally flared shape which can become even more flared when compressed onto a surface to which it is pressed and onto which it conforms under the atmospheric pressure when a (partial) vacuum is induced therein.

According to an embodiment of the disclosure, the thickness of the flexible body 1223 can be substantially constant along its length. A small variation in thickness can be expected at the rims and waists, or at the lip.

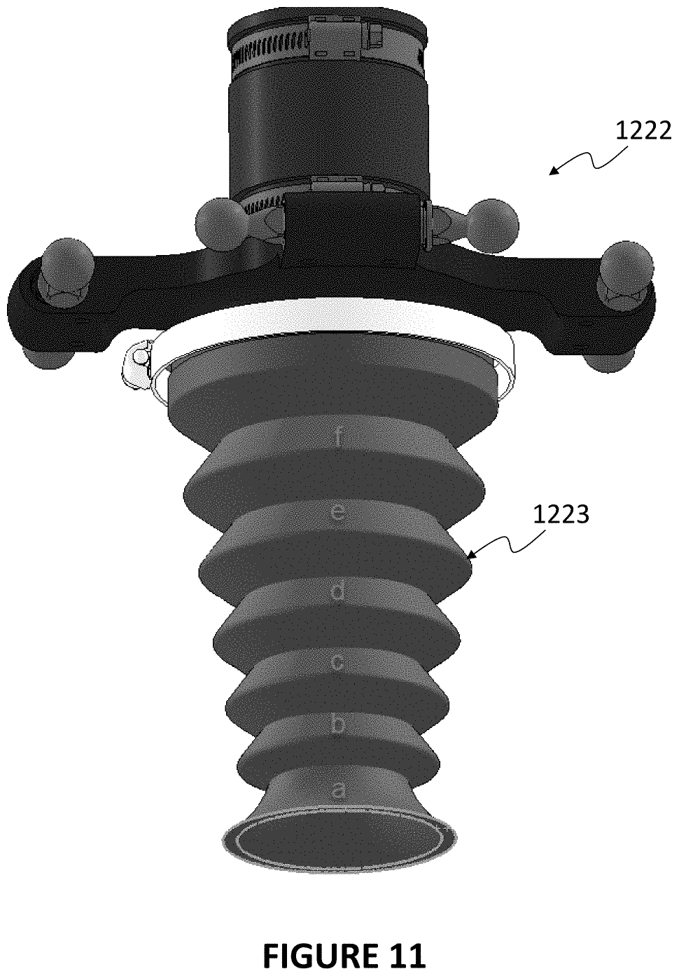

According to another embodiment of the disclosure, and referring to FIG. 11, the thickness of the flexible body 1223 can be variable between each wall portion extending between a rim and a waist. This thickness can be variable between the walls, despite having the flexible body 1223 integrally formed as a single piece of material by molding, as long as the molding can be performed to provide this varying thickness. The thickness can be selected to be preferably thin to avoid unnecessary mass of the flexible body 1223, taking into account that it needs to be moved very fast and frequently during operation. However, the thickness should be sufficient to provide a minimum level of rigidity such that the flexible body 1223 can generally maintain its shape which gives it adequate mechanical properties.

According to this embodiment of the disclosure, the flexible body 1223 can be divided in stages, comprising the distalmost horn stage (horn 1228 and lip 1229), labelled as stage a in FIG. 11; and successive stages labelled from b (distal) to f (proximal), each formed by a pair of a rim 1224 and an adjacent waist 1225 and the inclined continuous wall 1227 in between. With this nomenclature, the stage thicknesses can be as follows (in inches):
a. (this stage being the horn) Between about 0.08″ and about 0.14″; preferably between about 0.10″ and 0.12″; preferably about 0.11″;
b. About 0.2″ more than a, for example preferably about 0.13″;
c. About the same as b., for example preferably about 0.13″;
d. About 0.2″ more than b or c, for example preferably about 0.15″
e. About 0.2″ more than d, for example preferably about 0.17″;
f. About 0.2″ more than e, for example preferably about 0.19″.

It will be noted that the thickness is higher in the distal stages, such as in the horn 1228 and the most distal rim and waist, and increases in the proximal direction as the cross-section diameter also increases, toward the proximal direction. The thickness increase for each pair of rim 1224 and waist 1225 (together forming a stage) is about 0.2″ per stage, although adjacent stages may have the same thickness, especially those closest to the horn 1228.

Such a selection of thickness in the material forming the stages is used to ensure that the lateral displacement of the horn 1228 undergoing an acceleration of 3 g would be kept under 2 inches or about 5 centimeters. It also contributes to the ability of the suction tool 1222 to grab and lift objects weighing up to 6 pounds. In particular, the thickness of a stage should increase if the cross-section diameter (or diagonal) increases, to maintain the same level of axial rigidity (in the longitudinal axis of the tubular suction tool 1222) over the stages despite their diameter being larger at the top (proximal stages) than at the bottom (distal stages). Also, the values of the successive local rim diameters and local waist diameters, as well as the height of each stage (all described below), are also selected to ensure that the lateral displacement under significant accelerations and the weight-lifting capacity are among the targets mentioned just above.

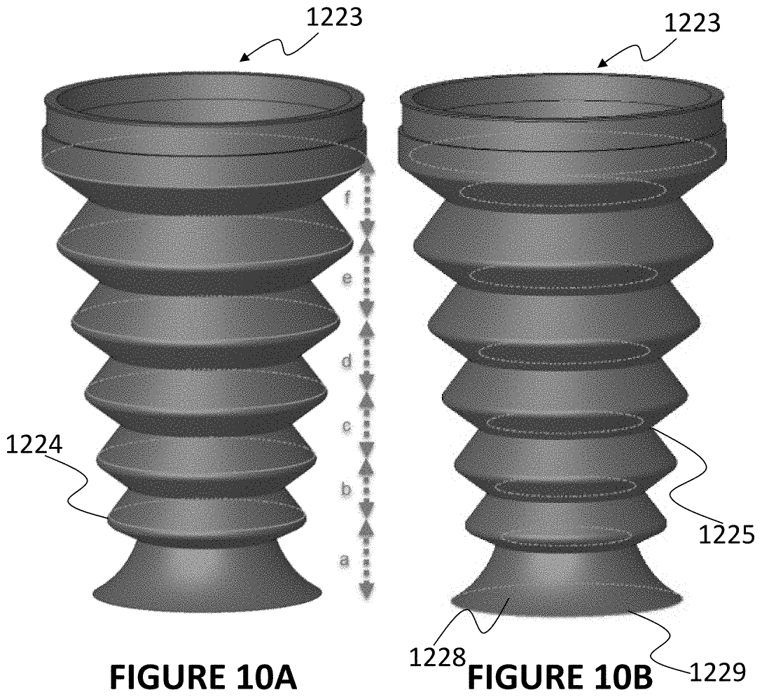

Indeed, referring to FIG. 10B, the local waist diameters of stages a-f as mentioned above can be as follows:
a. Between about 1.8″ and 2.0″, or between between about 1.0″ and 2.0″ if using a venturi system allowing smaller diameters; preferably about 1.91″;
b. About 0.15″ more than a, for example preferably about 2.06″
c. About 0.24″ more than b, for example preferably about 2.30″
d. About 0.20″ more than c, for example preferably about 2.50″
e. About 0.24″ more than d, for example preferably about 2.74″
f. About 0.27″ more than e, for example preferably about 3.01″

The local waist diameter of the first (most proximal) and smallest waist is chosen to define the width threshold by which items are statically grabbed or dynamically sucked up through the tubing.

Similarly, referring to FIG. 10A, the local rim diameters of stages a-f as mentioned above can be as follows:
a. Between about 2.8″ and about 3.0″, preferably about 2.92″
b. About 0.30″ more than a, for example preferably about 3.22″
c. About 0.34″ more than b, for example preferably about 3.56″
d. About 0.39″ more than c, for example preferably about 3.95″
e. About 0.41″ more than d, for example preferably about 4.36″
f. About 0.45″ more than e, for example preferably about 4.81″

In other words, each rim has said local rim diameter between about 0.30″ and increasing to about 0.45″ larger the local rim diameter of a next one of the rims, a smallest one of the local rim diameter being between about 2.8″ and about 3.0″. Each waist has said local rim diameter between about 0.15″ and about 0.27″ larger the local waist diameter of a next one of the waists, a smallest one of the local waist diameter being between about 1.0″ and about 2.0″.

Each rim 1124 has a local rim diameter larger than a local waist diameter of a next adjacent one of the waists 1125, the difference between the local rim diameter and the local waist diameter of the next adjacent one of the waists ranging between 1.1″ in proximal stages and gradually decreasing down to 0.75″ for the distal stages (smallest diameters also have smallest rim/waist difference).

Now referring to the diameter of the horn 1228 and lip 1229, the smaller, proximal diameter of the horn 1228, corresponding to a waist, can have a diameter between about 1.4″ and about 2.2″, for example between about 1.6″ and about 2.0″, preferably about 1.81″. Similarly, the larger, distal diameter of the lip of the horn 1229 can have a diameter between about 2.5″ and about 3.5″, more precisely between about 2.8″ and about 3.2″, preferably about 2.99″. Since the horn 1228 is highly flexible, the deformed horn 1228 with a flared lip 1229 is expected to have an effective diameter of suction which is closer to the inner diameter of the horn and thereby closer to the preferred value of inner diameter of about 1.81″, which is a target value in order to optimize the conformation of the deformed suction tool 1223 during operation with the items being grabbed.

Similarly, referring to FIG. 11, the height of stages a-f as mentioned above can be as follows:
a. Between about 0.68″ and about 1.02″, preferably about 0.88″
b. About 0.14″ less than a, for example preferably about 0.74″
c. About 0.21″ more than b, for example preferably about 0.95″
d. About 0.09″ more than c, for example preferably about 1.04″
e. About 0.09″ more than d, for example preferably about 1.13″
f. About 0.11″ more than e, for example preferably about 1.24″

Having stages with a height which increases if their diameter or diagonal increases ensures that there is kept sufficient rigidity in each stage despite the increasing diameter of the flexible body 1223 of the suction tool 1222.

More specifically, regardless of the height of a stage, more proximal stages (those located higher) have a larger diameter to increase rigidity of that stage to prevent flexion or shearing of the suction tool 1222 during lateral accelerations (the suction tool 1222 moving sideways and changing directions very fast thus undergoing large accelerations at a high frequency). However, large diameters in a given stage may cause that stage to collapse. Therefore, to avoid this inappropriate mechanical behavior, the stages are designed to have a greater height and a greater wall thickness when their diameter is larger to avoid longitudinal collapsing.

Providing a flexible body 1223 which, on average, decreases in diameter in the distal direction (or equivalently: increases in the proximal direction), with the thickness variations and diameter variations described above, ensures that the flexible body 1223 is able to retract with a significant and sufficient amplitude by itself when contacting an object and undergoing suddenly decreasing pressure (vacuum). Also the number of stages (rim and waist) is higher than the embodiment of the flexible body 1223 described in reference with FIGS. 8A-8D, which helps in giving a higher amplitude of retraction of the flexible body 1223. The overall length L, as shown in FIG. 9B, between the rigid portion of the tube connector 1299 and the lip 1229 should be between about 5″ and about 10″, preferably between about 6.5″ and about 8.5″, preferably about 7.45″. This implies that both the spring connector 295 and the inner vacuum sleeve 297 described in reference with FIGS. 8A-8D can be avoided. The spring connector 295 is a moving part with a spring which is hard to maintain, subject to high vibrations and repeated deformation which can use prematurely and needs to be replaced, as well as being vulnerable to dust and particulate matter. The inner vacuum sleeve 297 is also a moving part which is inside the apparatus, less accessible while having interstices and joints exposed to dust and particulate matter. The present embodiment described in reference with FIGS. 9A-11 can avoid the need to have any of these moving parts vulnerable to wear and, accordingly, are much easier to maintain and more resistant to harsh conditions.

The most proximal rim of the flexible body 1223 can be attached to a tubing connector 1299 which connects to the tubing 290, thereby providing a more direct connection of the flexible body 1223 to the tubing 290, since the flexible body 1223 is now designed such that it can undergo by itself a sufficient amplitude of deformation with requiring any other moving part (spring or slidable elements) in between.

In order to ensure that the vacuum effect is well transmitted into the flexible body 223, the tubing connector 1299 comprises an inside duct to act as an extender between the tubing 290 and the lumen of the flexible body 1223.

Handles 292 can be added to the tubing connector 1299, as shown in FIGS. 9A-9B and 11. In particular, the handles 292 can be used to pivotally attach the distal ends of the arms 212, which are described above in reference to FIG. 2.

Advantageously, the suction tool 1222 is flexible enough, thanks to the tapered diameter, frustoconical or frustopyramidal shape underlying the bellow-like folds of the flexible material, to undergo deformations of adequate amplitude which make it auto-retractable This auto-retractability makes the robot able to work at a higher picking frequency, since the trajectory of the tool is optimized and better controlled (also implying less collisions with objects), making the robot more efficient overall for picking. Also, this auto-retractability avoids the use of moving parts (spring, sliding means) and removes joints or interstices between parts, so the removal of mechanical parts and the smaller number of parts implies less maintenance requirements, less downtime due to stuck parts, and less frequently broken parts. The operation is also less noisy when compared to a device having a spring and sliding parts.

In addition to the advantages and constraints mentioned above, the suction tool 1222 should be able to grab an item on the conveyor in a few milliseconds, but less than 10 milliseconds. The amplitude of the vertical retraction should be significant but not more than 4 inches to avoid too ample deformations. The the suction tool 1222 should be able to withstand dusty environments thanks to the absence of sliding parts and given that most of the mechanical displacement is provided by the longitudinal and also radial deformation of the suction tool 1222 itself. The material used for it should also resist to abrasion and tearing. It should operate in an environment between −20° C. and 40° C., and with a degree of moisture of 100% if the items are wet. Within these constraints, thanks to the features discussed above, the suction tool 1222 should have a mechanical availability of about 98% or more.

For example, and without limitation, the sorting apparatus 20 with the suction tool 222 or preferably the suction tool 1222, can be used to grab items such as HDPE containers, LDPE grocery bags (empty), Tetrapak™ containers, milk cartons and other multi-layer food packaging), plastic objects made of PET or PVC, aluminum objects of different shapes, etc.

For example, and without limitation, the sorting apparatus 20 with the suction tool 222 or preferably the suction tool 1222, can be used in the following applications: Sorting rejects from mixed paper material flow, to evacuate from the flow on the conveyor items such as Tetrapak™ containers, PVC, HDPE, PET, aluminum, and all non-mix paper. Other examples can include different combinations of these materials (e.g., sorting PVC by evacuating all other elements, etc.).

While preferred embodiments have been described above and illustrated in the accompanying drawings, it will be evident to those skilled in the art that modifications may be made without departing from this disclosure. Such modifications are considered as possible variants comprised in the scope of the disclosure.

1. A suction tool for a system for sorting materials with a vacuum tube, the suction tool comprising:
a body of flexible material wall to be installed at a distal end of the vacuum tube and forming a tubular wall, the tubular wall being shaped with alternating rims and waists, and from a proximal end of the suction tool to a distal end thereof; an average diameter increasing proximally over a length of the body of flexible material.

2. The suction tool of claim 1, wherein each rim has a local rim diameter larger than a local waist diameter of a next adjacent one of the waists.

3. The suction tool of claim 2, wherein each rim has a local rim diameter larger than a local waist diameter of a next adjacent one of the waists, toward a proximal direction, by a difference between about 0.75″ and 1.1″.

4. The suction tool of claim 2, wherein the average diameter increasing proximally over the length of the body of flexible material is implemented by having each rim having said local rim diameter larger the local rim diameter of a next one of the rims; each waist having said local waist diameter larger the local waist diameter of a next one of the waists.

5. The suction tool of claim 4, wherein each rim has said local rim diameter between about 0.3″ and about 0.45″ larger the local rim diameter of a next one of the rims, a smallest one of the local rim diameter being between about 2.8″ and about 3.0″.

6. The suction tool of claim 5, wherein each waist has said local waist diameter between about 0.15″ and about 0.27″ larger the local waist diameter of a next one of the waists, a smallest one of the local waist diameter being between about 1.0″ and about 2.0″.

7. The suction tool of claim 4, wherein the body ends at the distal end with a horn having a flared edge forming a lip to enter in contact with items to be handled by the system for sorting materials.

8. The suction tool of claim 7, wherein the body is integrally made of a single piece.

9. The suction tool of claim 8, wherein the body is made of rubber.

10. The suction tool of claim 8, wherein the body is made of neoprene.

11. The suction tool of claim 10, wherein the body has a Shore A hardness between about 45 and about 55.

12. A suction tool for a system for sorting materials with a vacuum tube, the suction tool comprising:
a body of flexible material wall to be installed at a distal end of the vacuum tube and forming a tubular wall, the tubular wall being shaped a succession of stages which are integrally formed with each other in a single piece, with alternating rims and waists, each pair of a rim and waist and connecting wall in between defining one of the stages, and from a proximal end of the suction tool to a distal end thereof; each one of the stages is larger than a next adjacent one of the stages.

13. The suction tool of claim 1, wherein each rim has a local rim diameter larger than a local waist diameter of a next adjacent one of the waists within a same stage.

14. The suction tool of claim 13, wherein the rim of each stage is between about 0.75″ and 1.1″ larger in diameter than the rim of a next adjacent one of the stages.

15. The suction tool of claim 12, wherein the rim of each stage has said is between about 0.30″ and about 0.45″ larger the rim of a next one of the stages, a smallest one of the rims being between about 2.8″ and about 3.0″.

16. The suction tool of claim 12, wherein the rim of each stage is between about 0.15″ and about 0.27″ larger the rim of a next one of the stages, a smallest one of the rims being between about 1.8″ and about 2.0″.

17. The suction tool of claim 14, wherein the body ends at the distal end with a horn having a flared edge forming a lip to enter in contact with items to be handled by the system for sorting materials.

18. The suction tool of claim 17, wherein the body is made of rubber.

19. The suction tool of claim 17, wherein the body is made of neoprene.

20. The suction tool of claim 10, wherein the body has a Shore A hardness between about 45 and about 55.
